(19) United States
(12) Patent Application Publication
(10) Pub. No.: US 2020/0233578 A1
(43) Pub. Date: Jul. 23, 2020

(54) OPERATING METHOD FOR TOUCH DISPLAY DEVICE

(71) Applicant: Qisda Corporation, Taoyuan City (TW)

(72) Inventors: Hao-Lun TANG, Changhua County (TW); Hsiang-Yun CHIU, Hsinchu City (TW)

(73) Assignee: Qisda Corporation, Taoyuan City (TW)

(21) Appl. No.: 16/729,546

(22) Filed: Dec. 30, 2019

(30) Foreign Application Priority Data
Jan. 22, 2019 (CN) 201910059220.4

(51) Int. Cl. G06F 3/0488; G06F 3/0481; G06F 3/0484

(52) U.S. Cl. CPC G06F 3/04886; G06F 3/04842; G06F 3/04817

(57) ABSTRACT

An operating method for a touch display device is provided. The operating method includes the following steps. At least two targets are displayed on a display screen, wherein the at least two targets are circled by a selected range. When a first touch event occurring at a position corresponding to the selected range is detected, a control function is activated for the at least two targets in the selected range until the first touch event is not detected. When the control function is activated, whether a second touch event occurs is detected. When the control function is activated and the second touch event occurs, different control actions are performed respectively to the at least two targets in the selected range according to the behavior of the second touch event.

This application claims the benefit of People's Republic of China Application No. 201910059220.4, filed Jan. 22, 2019, the disclosure of which is incorporated by reference herein in its entirety.

### BACKGROUND OF THE INVENTION

### Field of the Invention

The invention relates in general to an operating method, and more particularly to an operating method for a touch display device.

### Description of the Related Art

Along with the advance in technology, the functions provided by the touch display device are getting more and more diversified. For example, diversified menu icons are displayed on the display screen for the user to perform various control actions to the targets. When the diversified menu icons are provided, the user needs to switch the menu for several times in order to perform a particular control action to the target, and this is indeed very inconvenient in terms of use.

### SUMMARY OF THE INVENTION

The invention is directed to an operating method for a touch display device capable of resolving the problems encountered in the prior art.

According to an embodiment of the present invention, an operating method for a touch display device is provided. The operating method includes the following steps. At least two targets are displayed on a display screen, wherein the at least two targets are circled by a selected range. When a first touch event occurs at a position corresponding to the selected range, a control function is activated for the at least two targets in the selected range until the first touch event is not detected. When the control function is activated, whether a second touch event occurs is determined. When the control function is activated and the second touch event occurs, different control actions are performed respectively to the at least two targets in the selected range according to the behavior of the second touch event.

According to another embodiment of the present invention, an operating method for a touch display device is provided. The operating method includes the following steps. A medical image is displayed on a display screen of the touch display device. A first target and a second target are provided in the medical image, wherein the first target and the second target overlap with each other. A first touch event is generated. A second touch event is generated during the process of generating the first touch event. When the second touch event is a movement in a first direction, a first control action is performed to the first target. When the second touch event is a movement in a second direction, a second control action is performed to the second target.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a flowchart of an operating method for a touch display device according to the present invention embodiment.

FIG. 2 is a schematic diagram of an image displayed on the display screen of the touch display device according to an embodiment of the present invention.

FIGS. 3-6 are schematic diagrams of an operating method for a touch display device according to an embodiment of the present invention.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention. Besides, secondary elements are omitted in the drawings of the embodiments, so that technical features of the present invention can be more clearly illustrated.

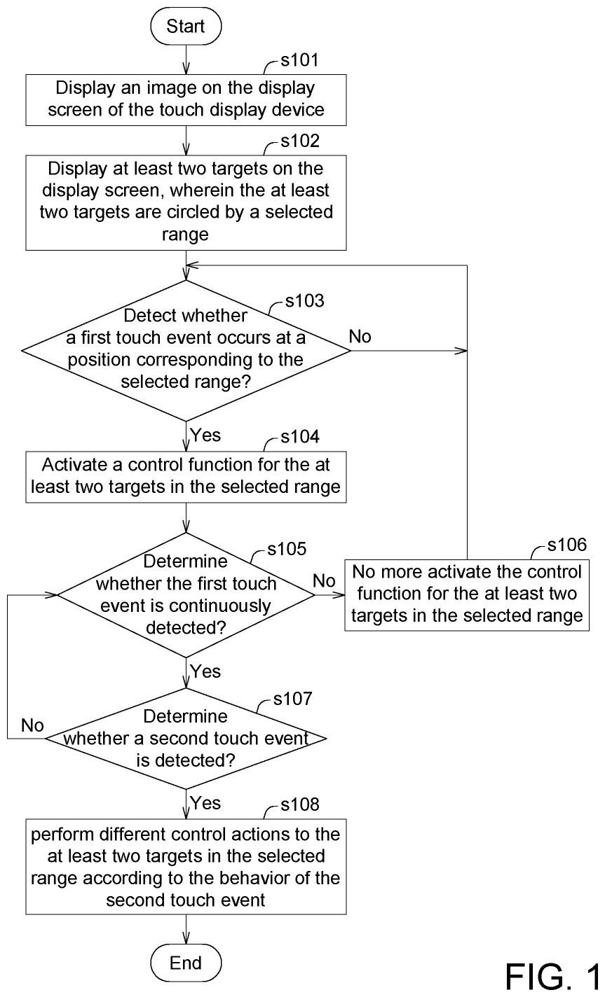

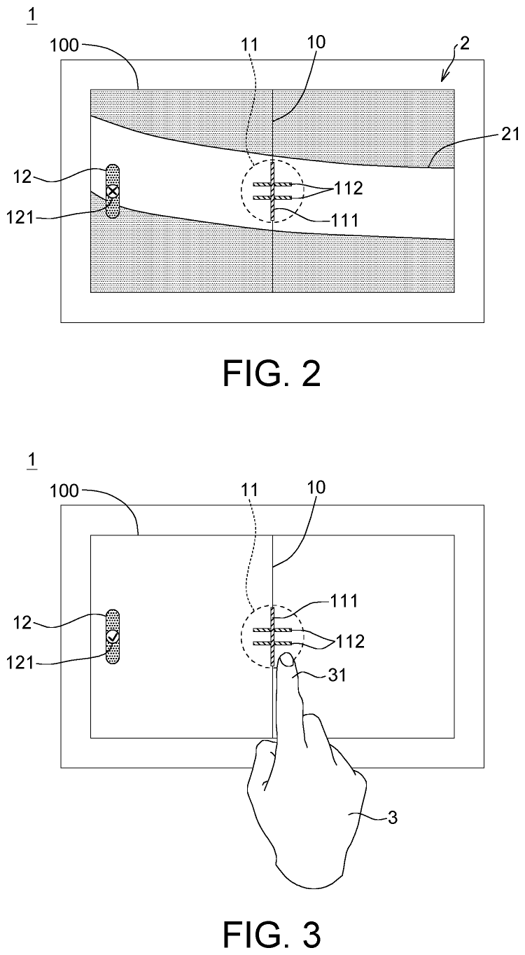

FIG. 1 is a flowchart of an operating method for a touch display device 1 according to the present invention embodiment. FIG. 2 is a schematic diagram of an image 2 displayed on the display screen 100 of the touch display device 1 according to an embodiment of the present invention.

The touch display device 1 can be realized by any device which includes a display screen 100 capable of displaying an image 2 and allowing touch control. The display device 1 can be realized by such as a smart phone, a tablet, a computer screen, a TV screen, a smart watch, or a medical image display screen.

FIGS. 3-6 are schematic diagrams of an operating method for a touch display device 1 according to an embodiment of the present invention. To simplify the drawings and highlight the features of the present invention, the image 2 of FIG. 2 is omitted in FIGS. 3-6.

Refer to FIG. 1 and FIG. 2. In step s101, an image 2 is displayed on the display screen 100 of the touch display device 1. In the present embodiment, the image 2 displayed on the display screen 100 can be a medical image, which may include a blood vessel image 21 photographed using ultrasound angiography. The present embodiment is for exemplary and explanatory purpose only, not for limiting the present invention.

In step s102, at least two targets, such as a first target 111 and a second target 112, are displayed on the display screen 100 by the touch display device 1. In an embodiment, the touch display device 1 further displays an ultrasound cursor 10 on the display screen 100, wherein at least two targets 111 and 112 are displayed on the ultrasound cursor 10. In the present embodiment, the blood vessel image 21 can be scanned using the pulse wave (PW) Doppler mode, such that the blood flow along the ultrasound cursor 10 in the target range can be selectively studied. In the present example, the first target 111 can be relevant with blood flow, and the second target 112 can be relevant with blood sampling volume.

The at least two targets 111 and 112 are circled by a selected range 11. The selected range 11 is smaller than the display screen 100 and is configured to determine whether the targets in the range are selected or not. In an embodiment, the at least two targets 111 and 112 overlap with each other.

Under such circumstance, the user can select and operate the at least two targets 111 and 112 in the selected range 11 with the assistance of the selected range 11.

In step s103, whether a first touch event occurs is detected by the touch display device 1, and the first touch event occurs at a position corresponding to the selected range 11.

For example, as indicated in FIG. 3, when the user 3 touches the display screen 100 with his/her finger (such as the index finger 31) and the touch position is in the selected range 11 or on the circle line (such as the dotted line) of the selected range 11, this implies that the user 3 intends to operate the at least two targets 111 and 112 in the selected range 11, and the method proceeds to step s104.

In step s104, a control function is activated for the at least two targets 111 and 112 in the selected range 11 by the touch display device 1. In an embodiment, the display screen 100 may further display a prompt icon 12, wherein the prompt symbol 121 of the prompt icon 12 indicates whether the control function is activated.

For example, when the control function is activated, the prompt symbol 121 of the prompt icon 12 is a tick as indicated in FIG. 3. When the control function is not activated, the prompt symbol 121 of the prompt icon 12 is a cross as indicated in FIG. 2.

The prompt icon 12 of the present invention is not limited to the above exemplifications. In other embodiments, the prompt icon 12 can indicate whether the control function is activated by changing the color of the display screen 100, changing the color of the at least two targets 111 and 112 in the selected range 11 or other methods.

When the control function is activated, the touch display device 1 may further move the at least two targets 111 and 112 in the selected range 11 according to the first touch event, such as the trajectory of the first touch event.

For example, the user 3 can move his/her index finger 31 to the top, the bottom, the left or the right of the display screen 100, such that the at least two targets 111 and 112 in the selected range 11 can be moved and their positions in the image 2 can be changed accordingly.

Then, the method proceeds to step s105, whether the first touch event is continuously detected is determined by the touch display device 1. If the determination is negative, this implies that the index finger 31 of the user 3 has left the display screen 100, and the method proceeds to step s106, the control function is no more activated for the at least two targets 111 and 112 in the selected range 11, meanwhile, the prompt symbol 121 of the prompt icon 12 is a cross. If the determination is positive, this indicates that the user 3 continues to touch the display screen 100 with his/her index finger, the control function continues to be activated, then the method proceeds to step s107, whether a second touch event occurs is detected.

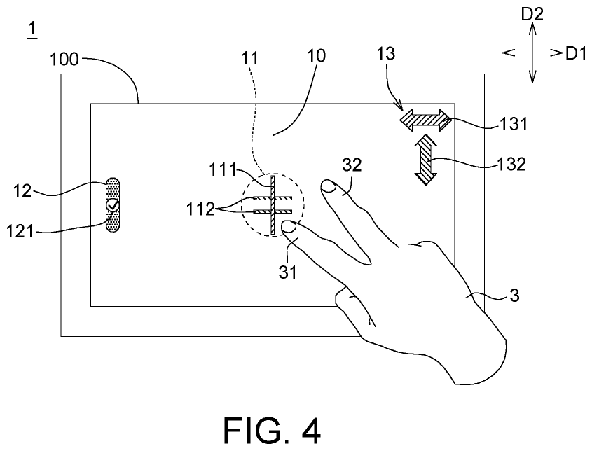

Refer to FIG. 4. When the user 3 touches the display screen 100 with another finger (such as the middle finger 32), the touch display device 1 detects a second touch event, and the method proceeds to step s108.

In step s108, different control actions are respectively performed to the at least two targets 111 and 112 in the selected range 11 by the touch display device 1 according to the behavior of the second touch event.

In an embodiment, as indicated in FIG. 4, when the control function is activated (the prompt symbol 121 of the prompt icon 12 is a tick) and the second touch event occurs (the middle finger 32 touches the display screen 100), the touch display device 1 can display a prompt indicator 13 to prompt the user 3 what gesture operations are available for the user to perform different control actions to the at least two targets 111 and 112 in the selected range 11.

For example, when the second touch event is a movement in a first direction D1, a first control action can be performed to the first target 111; when the second touch event is a movement in a second direction D2, a second control action can be performed to the second target 112. In the present embodiment, the first direction D1 and the second direction D2 are different directions parallel to the display screen 100 and can be perpendicular or non-perpendicular to each other, and the present invention is not limited thereto. One of the first direction D1 and the second direction D2 can be perpendicular to the display screen 100. The first control action and the second control action can be rotating, scaling or moving the target or a combination thereof.

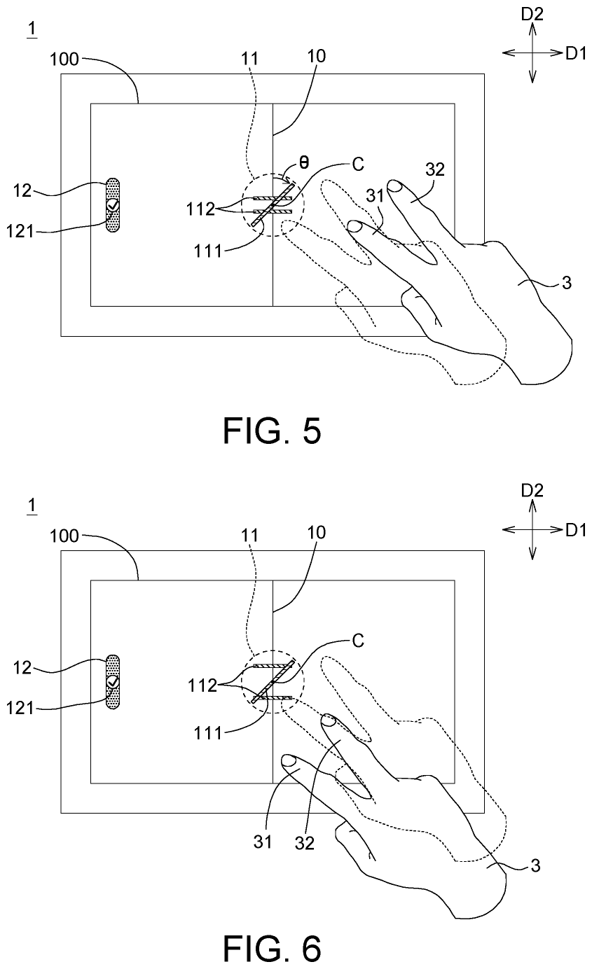

Refer to FIG. 5. If the first target 111 is relevant with blood flow, the first direction D1 can be the direction of the leftward and the rightward movement on the display screen 100, and the first control action can be the action for rotating the first target 111 to adjust the angle of the first target 111. When the second touch event is a rightward movement, the first target 111 can be rotated by an angle of 8 in a clockwise direction using the center point C as the center of circle. When the second touch event continues to move rightward, the first target 111 can be rotated by a larger angle in a clockwise direction.

Conversely, when the second touch event is a leftward movement, the first target 111 can be rotated by an angle of θ in an anti-clockwise direction using the center point C as the center of circle. When the second touch event continues to move leftward, the first target 111 can be rotated by a larger angle in an anti-clockwise direction. Thus, the angle of the first target 111 can be adjusted, such that the first target 111 can be aligned with the bold flow direction of the blood vessel image 21 (illustrated in FIG. 2) and the blood flow rate can be measured.

Refer to FIG. 6. If the second target 112 is relevant with the blood sampling volume, the second direction D2 can be the direction of the upward and the downward movement on the display screen 100, and the second control action can be the action for changing the interval of the second target 112 to adjust the volume of the second target 112. When the second touch event is an upward movement, the second target 112 can synchronically be moved away from the center point C. When the second touch event continues to move upward, the second target 112 can be moved further away from the center point C. Conversely, when the second touch event is a downward movement, the second target 112 can be synchronically moved closer towards the center point C. When the second touch event continues to move downward, the second target 112 can be further closer towards the center point C. Thus, the volume of the second target 112 can be adjusted, and the user can selectively check the data of blood flow rate in the range of the sampling volume of the second target 112 along the ultrasound cursor 10.

Refer to FIG. 4. In another embodiment, the prompt indicator 13 may further include a first arrow indicator 131 and a second arrow indicator 132. The first arrow indicator 131 corresponds to the first direction D1, and the second arrow indicator 132 corresponds to the second direction D2. Besides, the first arrow indicator 131 and the first target 111 have the same first appearance, such as the same color; the second arrow indicator 132 and the second target 112 have the same second appearance, such as the same color different from that of the first appearance. Or, the prompt indicator 13, such as a prompt message, prompts the user 3 which behavior is available and which target receives corresponding control action of the said behavior. Thus, the user 3 can operate more conveniently.

In step s108, the first touch event and the second touch event can be iso-directional movements, that is, the trajectory of the index finger 31 and the trajectory of the middle finger 32 can synchronically move towards the same direction. As indicated in FIG. 5, the index finger 31 and the middle finger 32 can synchronically move towards the right of the display screen 100. As indicated in FIG. 6, the index finger 31 and the middle finger 32 can move synchronically towards the bottom of the display screen 100. Thus, the user 3 can operate using one hand, and the operation is very convenient.

In above embodiments, only two targets are provided in the selected range. It can be understood that more targets can be provided in the selected range as long as each target corresponds to one of the behaviors of the second touch event, necessary control action can be performed to the particular target. For example, apart from the first direction and the second direction exemplified in the above embodiments, the movements in other directions, such as the direction moving towards the bottom right corner from the top left corner of the display screen or the direction moving towards the bottom left corner from the top right corner of the display screen.

According to the operating method disclosed in above embodiments, when the user touches the selected range with one finger, the control function can be activated. Meanwhile, when the user slides his/her finger, the selected range and the targets therein can be moved. Given the user's one finger still touches the selected range, the user can perform different control actions to different targets by touching the display screen with another finger and further moving or sliding the other finger along a different direction.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An operating method for a touch display device, the operating method comprising:
displaying at least two targets on a display screen, the at least two targets circled by a selected range;
activating a control function for the at least two targets in the selected range when a first touch event occurring at a position corresponding to the selected range is detected until the first touch event is not detected;
detecting whether a second touch event occurs when the control function is activated; and
respectively performing different control actions to the at least two targets in the selected range according to a behavior of the second touch event when the control function is activated and the second touch event occurs.

2. The operating method according to claim 1, wherein the step of respectively performing different control actions to the at least two targets in the selected range according to the behavior of the second touch event comprise:
performing a first control action to a first target when the second touch event is a movement in a first direction; and
performing a second control action to a second target when the second touch event is a movement in a second direction.

3. The operating method according to claim 2, wherein the first direction and the second direction are perpendicular or parallel to the display screen.

4. The operating method according to claim 2, wherein the first control action and the second control action are rotation, scaling, movement or a combination thereof.

5. The operating method according to claim 2, wherein when the control function is activated, the operating method further comprises:
displaying a first arrow indicator and a second arrow indicator on the display screen, wherein the first arrow indicator corresponds to the first direction, and the second arrow indicator corresponds to the second direction.

6. The operating method according to claim 5, wherein the first target and the first arrow indicator are displayed in a first appearance, and the second target and the second arrow indicator are displayed in a second appearance.

7. The operating method according to claim 1, wherein the at least two targets overlap with each other.

8. The operating method according to claim 1, wherein when the control function is activated, the operating method further comprises:
performing a movement control to the at least two targets in the selected range according to the first touch event.

9. The operating method according to claim 1, wherein when the control function is activated, the operating method further comprises:
displaying a prompt icon on the display screen to prompt that the control function has been activated.

10. The operating method according to claim 1, wherein during the process of respectively performing different control actions to the at least two targets in the selected range according to the behavior of the second touch event, the behaviors of the first touch event and the second touch event are iso-directional movements.

11. An operating method for a touch display device, the operating method comprising:
displaying a medical image on a display screen of the touch display device;
providing a first target and a second target in the medical image, wherein the first target and the second target overlap with each other;
generating a first touch event;
generating a second touch event during the process of generating the first touch event;
performing a first control action to the first target when the second touch event is a movement in a first direction; and
performing a second control action to the second target when the second touch event is a movement in a second direction.

12. The operating method according to claim 11, wherein the medical image further comprises a blood vessel image, the first target is relevant with blood flow, and the second target is relevant with blood sampling volume.

13. The operating method according to claim 11, wherein the first control action is for adjusting the angle of the first target, and the second control action is for adjusting the volume of the second target.

14. The operating method according to claim 11, wherein the first direction and the second direction are perpendicular or parallel to the display screen.

15. The operating method according to claim 11, wherein when the first touch event is generated, the operating method further comprises:
displaying a first arrow indicator and a second arrow indicator on the display screen, wherein the first arrow indicator corresponds to the first direction, and the second arrow indicator corresponds to the second direction.

16. The operating method according to claim 15, wherein the first target and the first arrow indicator are displayed in a first appearance, and the second target and the second arrow indicator are displayed in a second appearance.

17. The operating method according to claim 11, wherein the first touch event is generated at a position corresponding to the first target and the second target which overlap with each other.

18. The operating method according to claim 17, wherein during the process of generating the first touch event, the operating method further comprises:
performing a movement control to the first target and the second target, which overlap with each other according to the first touch event.

19. The operating method according to claim 17, wherein when the first touch event is generated, the operating method further comprises:
displaying a prompt icon on the display screen to prompt that the first target and the second target which overlap with each other have been selected.

20. The operating method according to claim 11, wherein when the second touch event is generated, the first touch event and the second touch event are iso-directional movements.
